(19) United States
(12) Patent Application Publication
(10) Pub. No.: US 2025/0273936 A1
(43) Pub. Date: Aug. 28, 2025

(54) CUTTING AND COMPRESSION DEVICES

(71) Applicant: Huskie Tools, LLC, Addison, IL (US)

(72) Inventor: Brent Wagner, Bartlett, IL (US)

(21) Appl. No.: 18/775,964

(22) Filed: Jul. 17, 2024

Related U.S. Application Data
(60) Provisional application No. 63/557,202, filed on Feb. 23, 2024.

(51) Int. Cl. H02G 1/00

(52) U.S. Cl. CPC H02G 1/005

(57) ABSTRACT

Devices include a first cutting portion, a second cutting portion spatially positioned to engage the first cutting portion during a cutting operation, a first compression portion, a second compression portion spatially positioned to engage the first compression portion during a compression operation, and an engaging mechanism. The engaging mechanism is operatively coupled to the first cutting portion, the second cutting portion, the first compression portion, and the second compression portion. Further, the engaging mechanism is configured to perform the cutting operation by engaging the first cutting portion and the second cutting portion, and the compression operation by engaging the first compression portion and the second compression portion.

### CROSS-REFERENCE TO RELATED APPLICATIONS

The present application claims priority to and benefit of U.S. Provisional Patent Application No. 63/557,202 filed Feb. 23, 2024 entitled CUTTING AND COMPRESSION JAW APPARATUS, the entire contents of which are hereby expressly incorporated by reference.

### TECHNICAL FIELD

One or more aspects of the present disclosure broadly relates to a mechanical device, and more particularly to a cutting and compression device.

### BACKGROUND

Handheld tools are used by utility linemen and professional electricians for various tasks. These tools may be manual, electric, battery powered, hydraulic, etc. Often, the tools utilize interchangeable attachment heads to perform different functions needed by professionals. For example, an electric tool may incorporate a chuck that holds or locks the interchangeable attachment heads in place during the various functions. However, switching out the interchangeable attachment heads between functions can introduce inefficiencies, can be time consuming, and can be inconvenient. Thus, a need exists to provide improved systems and devices to address these deficiencies.

### SUMMARY

Shortcomings of the prior art are overcome and additional advantages are provided through the provision of a jaw apparatus. The jaw apparatus includes a first jaw pivotably coupled to a second jaw at a fulcrum point, the first jaw having a first jaw length extending from a first jaw proximal end to a first jaw distal end and the second jaw having a second jaw length extending from a second jaw proximal end to a second jaw distal end, the fulcrum point being positioned more proximate both the first jaw proximal end and the second jaw proximal end than to the first jaw distal end and the second jaw distal end. The jaw apparatus further includes a first cutting portion positioned along the first jaw length more proximate the first jaw distal end than to the fulcrum point. The jaw apparatus further includes a second cutting portion positioned along the second jaw length more proximate the second jaw distal end than to the fulcrum point. The jaw apparatus also includes a first compression portion positioned along the first jaw length in between the fulcrum point and the first cutting portion, and a second compression portion positioned along the second jaw length in between the fulcrum point and the second cutting portion.

According to one embodiment of the invention, the first cutting portion comprises a first blade mount configured to receive a first detachable blade and the second cutting portion comprises a second blade mount configured to receive a second detachable blade.

According to one embodiment of the invention, the first blade mount and the second blade mount are aligned along the respective first jaw length and second jaw length when the first jaw and the second jaw are positioned in a closed position, the closed position engaging the first jaw and the second jaw such that the first jaw and the second jaw are adjoining.

According to one embodiment of the invention, when the first jaw and the second jaw are in the closed position and the first detachable blade is mounted to the first blade mount and the second detachable blade is mounted to the second blade mount, a first blade edge of the first detachable blade at least partially overlaps with a second blade edge of the second detachable blade.

According to one embodiment of the invention, at least one of the first blade edge and the second blade edge is concave.

According to one embodiment of the invention, the first compression portion comprises a first compression pocket configured to receive a first compression die of a compression die set and the second compression portion comprises a second compression pocket configured to receive a second compression die of the compression die set, wherein the first compression pocket and the second compression pocket are each semi-circular in shape such that a circular aperture is formed when the first compression pocket and the second compression pocket are aligned and adjoining.

According to one embodiment of the invention, the first compression portion comprises a first compression pocket configured to receive a first compression die of a compression die set and the second compression portion comprises a second compression pocket configured to receive a second compression die of the compression die set, wherein the first compression pocket and the second compression pocket are each semi-circular in shape such that a circular aperture is formed when the first compression pocket and the second compression pocket are aligned and adjoining.

According to one embodiment of the invention, the first jaw is pivotally coupled to the second jaw at the fulcrum point via a hinged connection between multiple knuckles, the multiple knuckles including a first knuckle of the first jaw, a second knuckle of the second jaw, a third knuckle of the first jaw, and a fourth knuckle of the second jaw, wherein a first receiving channel is positioned between the first knuckle and the third knuckle of the first jaw that is configured to receive one of the second knuckle and the fourth knuckle of the second jaw, and a second receiving channel is positioned between the second knuckle and the fourth knuckle of the second jaw that is configured to receive one of the first knuckle and the third knuckle of the first jaw.

According to one embodiment of the invention, each of the first knuckle, the second knuckle, the third knuckle, and the fourth knuckle comprise respective central apertures passing therethrough at the fulcrum point, the respective central apertures being configured to receive a pivot pin channel.

According to one embodiment of the invention, the pivot pin channel comprises a cylinder having first end configured to receive a first fastener and having a second end opposite the first end configured to receive a second fastener.

According to one embodiment of the invention, the jaw apparatus further includes a spring connecting the first jaw and the second jaw, the spring being positioned along the first jaw length relative the fulcrum point opposite from the first cutting portion and first compression portion of the first jaw and being positioned along the second jaw length relative the fulcrum point opposite from the second cutting portion and the second compression portion of the second jaw.

According to one embodiment of the invention, the spring is configured to bias open the first jaw and the second jaw when the jaw apparatus is not in operation.

According to one embodiment of the invention, the first cutting portion and the second cutting portion are capable of providing at least four tons of force when engaged, and wherein the first compression portion and the second compression portion are capable of providing at least four tons of force when engaged.

Also disclosed herein is a cutting and compression kit. The cutting and compression kit includes a cutting and compression jaw apparatus that includes a first jaw pivotably coupled to a second jaw at a fulcrum point, the first jaw having a first jaw length extending from a first jaw proximal end to a first jaw distal end and the second jaw having a second jaw length extending from a second jaw proximal end to a second jaw distal end, the fulcrum point being positioned more proximate both the first jaw proximal end and the second jaw proximal end than to the first jaw distal end and the second jaw distal end. The cutting and compression jaw also includes a first cutting portion positioned along the first jaw length more proximate the first jaw distal end than to the fulcrum point, and a second cutting portion positioned along the second jaw length more proximate the second jaw distal end than to the fulcrum point. The cutting and compression jaw also includes a first compression portion positioned along the first jaw length in between the fulcrum point and the first cutting portion, and a second compression portion positioned along the second jaw length in between the fulcrum point and the second cutting portion. The cutting and compression kit also includes a body assembly comprising a drive for operating the cutting and compression jaw apparatus.

According to one embodiment of the kit, the drive comprises at least one of an electromechanical drive and a hydraulic drive, wherein the drive is configured to pivot the first jaw relative the second jaw during operation.

According to one embodiment of the kit, the first cutting portion comprises a first blade mount configured to receive a first detachable blade and the second cutting portion comprises a second blade mount configured to receive a second detachable blade.

According to one embodiment of the kit, the first blade mount and the second blade mount are aligned along the respective first jaw length and second jaw length when the first jaw and the second jaw are positioned in a closed position, the closed position engaging the first jaw and the second jaw such that the first jaw and the second jaw are adjoining.

According to one embodiment of the kit, the first compression portion comprises a first compression pocket configured to receive a first compression die of a compression die set and the second compression portion comprises a second compression pocket configured to receive a second compression die of the compression die set, wherein the first compression pocket and the second compression pocket are each semi-circular in shape such that a circular aperture is formed when the first compression pocket and the second compression pocket are aligned and adjoining.

Also disclosed herein is a method that includes positioning an object to be cut between a first cutting portion of a first jaw of a cutting and compression apparatus and a second cutting portion of a second jaw of the cutting and compression apparatus, the first jaw having a first jaw length extending from a first jaw proximal end to a first jaw distal end and the second jaw having a second jaw length extending from a second jaw proximal end to a second jaw distal end, the cutting and compression apparatus including a fulcrum point positioned more proximate both the first jaw proximal end and the second jaw proximal end than to the first jaw distal end and the second jaw distal end, wherein the first cutting portion is positioned along the first jaw length more proximate the first jaw distal end than to the fulcrum point, and the second cutting portion is positioned along the second jaw length more proximate the second jaw distal end than to the fulcrum point. The method also includes engaging at least one of the first jaw and the second jaw such that a first blade of the first cutting portion engages a second blade of the second cutting portion, thereby cutting the object into a first portion and a second portion. The method also includes positioning one of the first portion and the second portion between a first compression portion of the first jaw and a second compression portion of the second jaw, the first compression portion being positioned along the first jaw length in between the fulcrum point and the first cutting portion, and the second compression portion being positioned along the second jaw length in between the fulcrum point and the second cutting portion. The method further includes re-engaging the at least one of the first jaw and the second jaw such that the first compression portion engages with the second compression portion thereby compressing the one of the first portion and the second portion positioned between the first compression portion and the second compression portion.

According to one embodiment of the method, the engaging the at least one of the first jaw and the second jaw includes activating an electromechanical drive operatively coupled to at least one of the first jaw and the second jaw, and the re-engaging the at least one of the first jaw and the second jaw comprises re-activating the electromechanical drive.

According to one embodiment of the method, the engaging the at least one of the first jaw and the second jaw applies at least four tons of force to the object, and wherein the re-engaging the at least one of the first jaw and the second jaw applies at least four tons of force.

According to one embodiment of the invention, a device includes a first cutting portion, a second cutting portion spatially positioned to engage the first cutting portion during a cutting operation, a first compression portion, a second compression portion spatially positioned to engage the first compression portion during a compression operation, and an engaging mechanism. The engaging mechanism is operatively coupled to the first cutting portion, the second cutting portion, the first compression portion, and the second compression portion, wherein the engaging mechanism is configured to perform (i) the cutting operation by engaging the first cutting portion and the second cutting portion, and (ii) the compression operation by engaging the first compression portion and the second compression portion.

According to one embodiment of the invention, a device includes a first cutting portion positioned on a fixed head, a first compression portion also positioned on the fixed head, a second cutting portion spatially positioned to engage the first cutting portion during a cutting operation, a second compression portion spatially positioned to engage the first compression portion during a compression operation, and an engaging mechanism operatively coupled to the second cutting portion and the second compression portion. Further, the engaging mechanism is configured to perform (i) the cutting operation by moving the second cutting portion towards the first cutting portion, and (ii) the compression operation by moving the second compression portion towards the first compression portion.

According to one embodiment of the invention, the device includes a first cutting portion positioned on a first rotatable support, a first compression portion also positioned on the first rotatable support, a second cutting portion positioned on a second rotatable support, a second compression portion also positioned on the second rotatable support, and an engaging mechanism operatively coupled to the first rotatable support and the second rotatable support. Further, the engaging mechanism is configured to rotate the first rotatable support to position the first cutting portion for a cutting operation and configured to rotate the second rotatable support to align the second cutting portion with the first cutting portion for the cutting operation. In addition, the engaging mechanism is configured to rotate the first rotatable support to position the first compression portion for a crimping operation and configured to rotate the second rotatable support to align the second compression portion with the first compression portion for the crimping operation, the crimping operation being a separate operation than the cutting operation.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 is a top front left-side perspective view of an example cutting and compression jaw apparatus, according to one embodiment;

FIG. 2 is another top front right-side perspective view of the example cutting and compression jaw apparatus of FIG. 1, according to one embodiment;

FIG. 3 is a bottom back perspective view of the example cutting and compression jaw apparatus of FIGS. 1-2, according to one embodiment;

FIG. 4 is a front elevational view of the example cutting and compression jaw apparatus of FIGS. 1-3, according to one embodiment;

FIG. 5 is a back elevational view of the example cutting and compression jaw apparatus of FIGS. 1-4, according to one embodiment;

FIG. 6 is a left-side elevational view of the example cutting and compression jaw apparatus of FIGS. 1-5, according to one embodiment;

FIG. 7 is a right-side elevational view of the example cutting and compression jaw apparatus of FIGS. 1-6, according to one embodiment;

FIG. 8 is a top elevational view of the example cutting and compression jaw apparatus of FIGS. 1-7, according to one embodiment;

FIG. 9 is a bottom elevational view of the example cutting and compression jaw apparatus of FIGS. 1-8, according to one embodiment;

FIG. 10 is an exploded top front right-side view of the example cutting and compression jaw apparatus of FIGS. 1-9, according to one embodiment;

FIG. 11 is a perspective view of an example kit that includes the example cutting and compression jaw apparatus of FIGS. 1-9 and an example body assembly, according to one embodiment;

FIG. 12 is a top front left-side perspective view of an example cutting and compression device, according to one embodiment;

FIG. 13 is a top front right-side perspective view of the example cutting and compression device of FIG. 12, according to one embodiment;

FIG. 14 is a bottom front left-side perspective view of the example cutting and compression device of FIGS. 12-13, according to one embodiment;

FIG. 15 is a bottom front right-side perspective view of the example cutting and compression device of FIGS. 12-14, according to one embodiment;

FIG. 16 is a front elevational view of the example cutting and compression device of FIGS. 12-15, according to one embodiment;

FIG. 17 is a back elevational view of the example cutting and compression device of FIGS. 12-16, according to one embodiment;

FIG. 18 is a top elevational view of the example cutting and compression device of FIGS. 12-17, according to one embodiment;

FIG. 19 is a bottom elevational view of the example cutting and compression device of FIGS. 12-18, according to one embodiment;

FIG. 20 is a left-side elevational view of the example cutting and compression device of FIGS. 12-19, according to one embodiment;

FIG. 21 is a right-side elevational view of the example cutting and compression device of FIGS. 12-20, according to one embodiment;

FIG. 22 is a perspective view of an example cutting and compression device with a fixed head, according to one embodiment;

FIG. 23 is a perspective view of an example cutting and compression device with a fixed head, according to one embodiment; and

FIG. 24 is a perspective view of an example cutting and compression device with rotatable supports.

### DETAILED DESCRIPTION

The following detailed description and appended drawings describe and illustrate various exemplary embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical.

“A” and “an” as used herein indicate “at least one” of the item is present; a plurality of such items may be present, when possible. Spatially relative terms, such as “front,” “back,” “inner,” “outer,” “bottom,” “top,” “horizontal,” “vertical,” “upper,” “lower,” “side,” “above,” “below,” “beneath,” “upwardly,” “outwardly,” “inwardly,” “right,” “left,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

As used herein, substantially is defined as “to a considerable degree” or “proximate” or as otherwise understood by one ordinarily skilled in the art or as otherwise noted. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

The terms “couple”, “coupled”, “couples”, “coupling”, “fixed”, “attached to”, “connect”, “connected”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context.

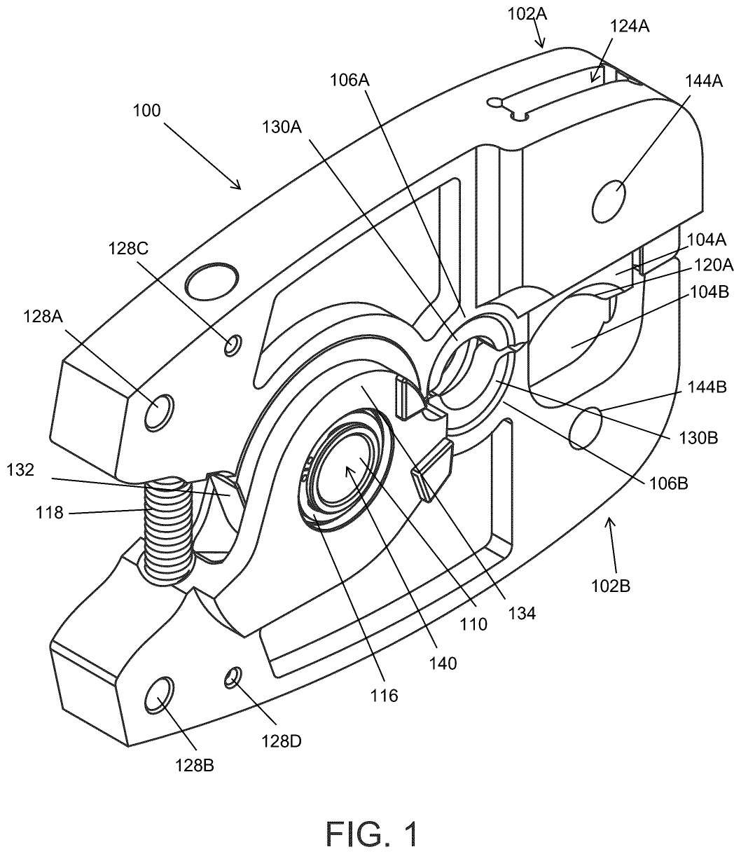

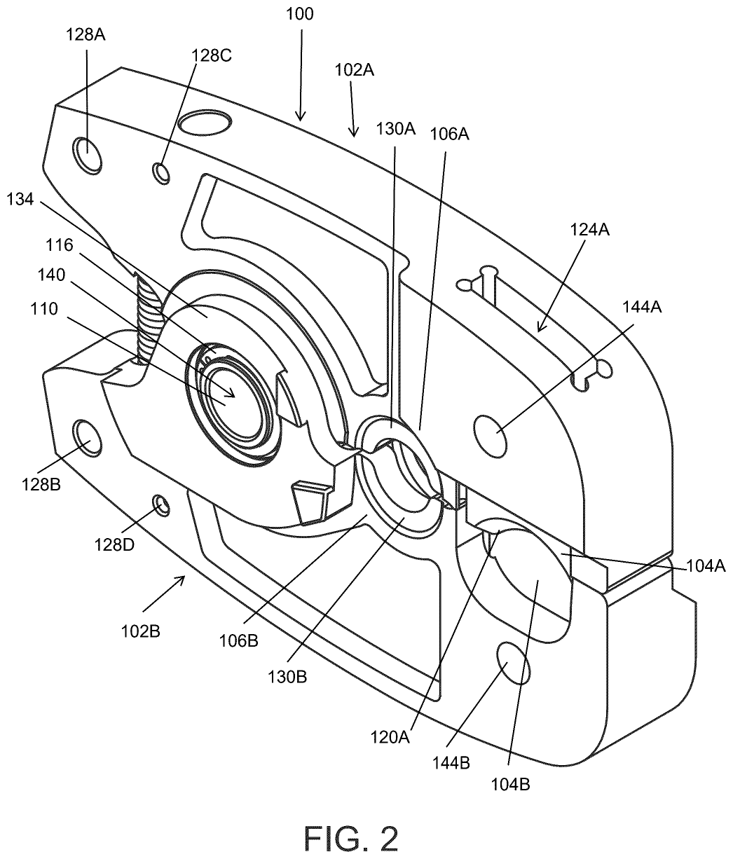

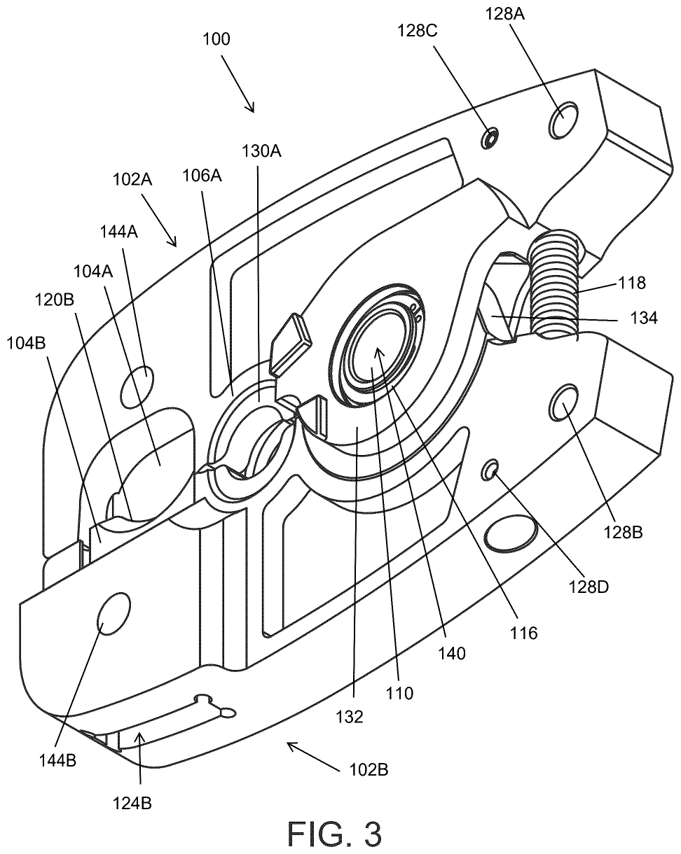

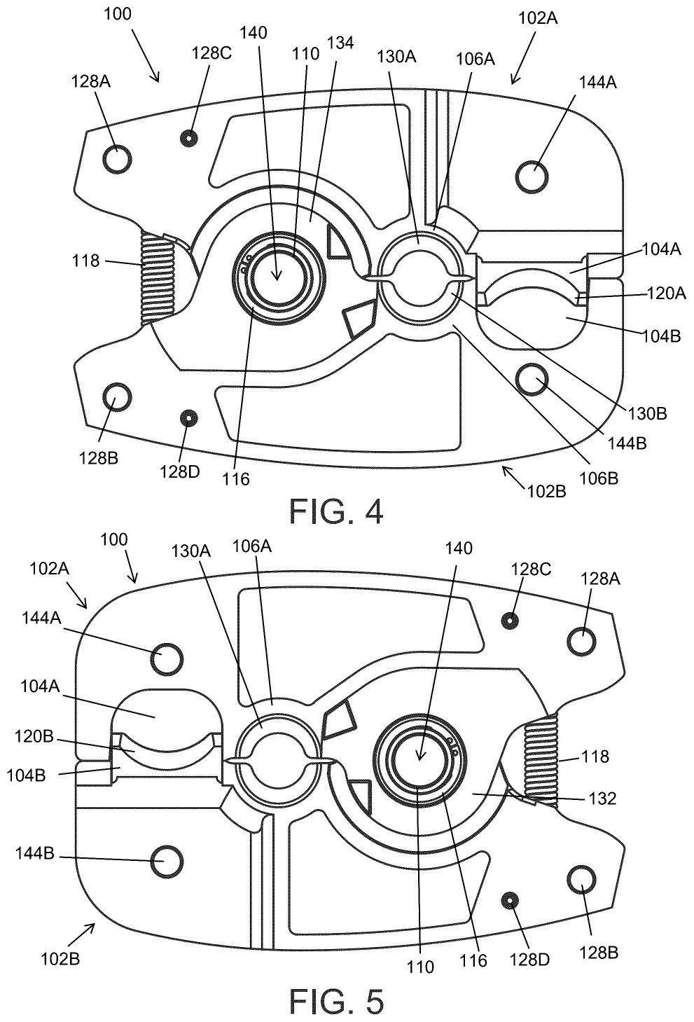

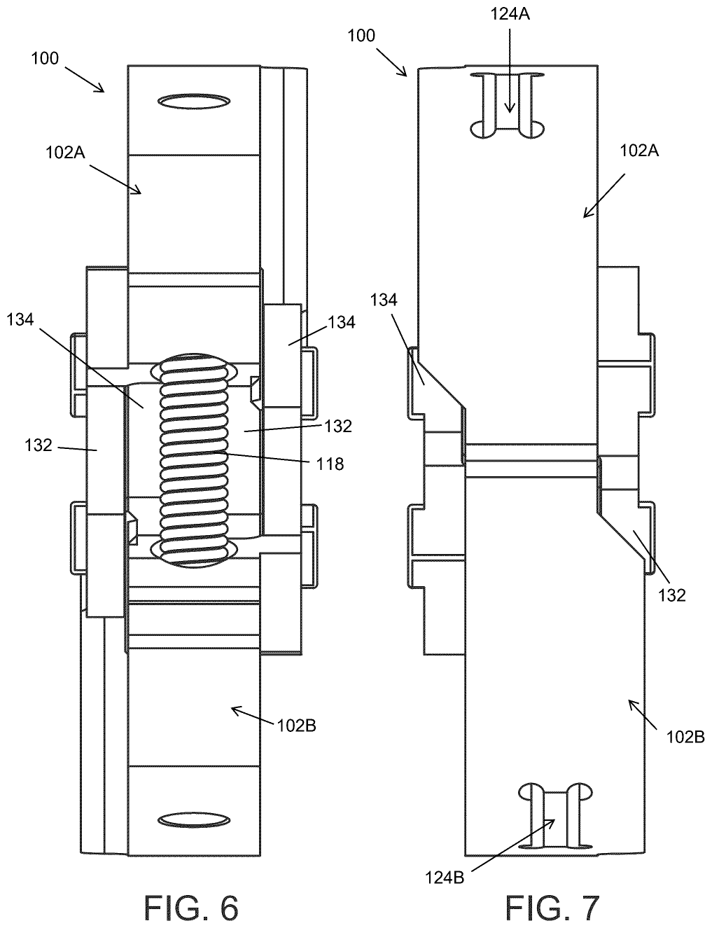

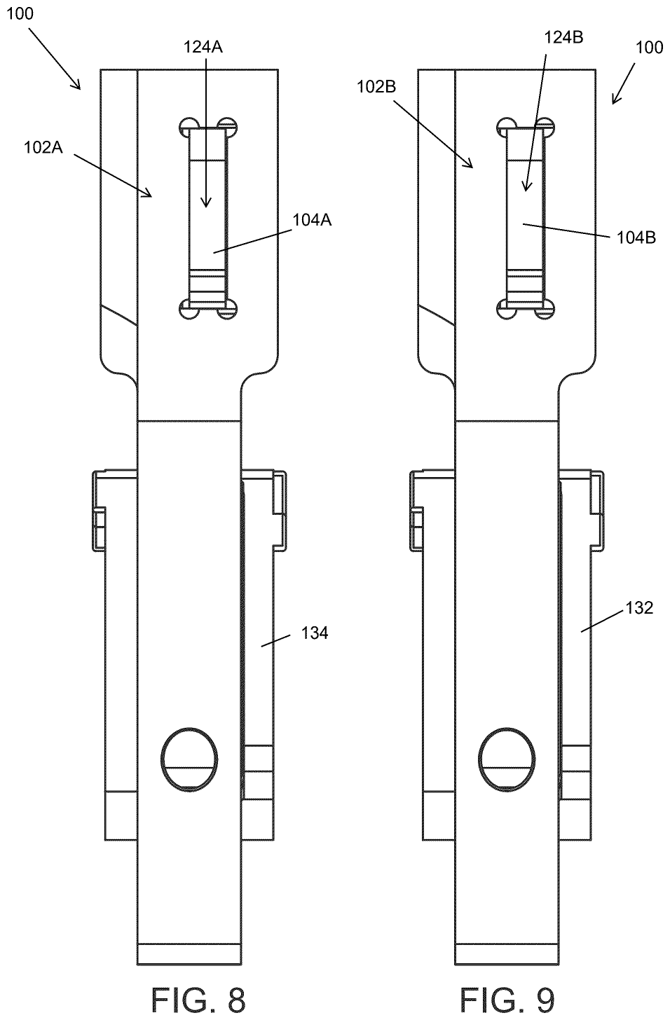

FIGS. 1-10 depict various views of a cutting and compression jaw apparatus 100. The cutting and compression jaw apparatus may be sized and shaped or otherwise configured to be coupled to a body assembly. The body assembly may be a manual or mechanical assembly or may be an electric or hydraulic assembly. Once the cutting and compression jaw apparatus 100 is coupled to the body assembly, the cutting and compression jaw apparatus 100 may be used to both cut and crimp a cable without having to remove the cutting and compression jaw apparatus from the body assembly. In particular, the cutting a compression jaw apparatus 100 is configured such that a user may insert a cable, such as a four-aught (4/0 or 0000) aluminum conductor steel reinforced (ASCR) cable, between a pair of jaws 102A, 102B. Example four-aught ASCR cables may be utilized in long, extra high voltage transmission lines or sub-service spans on a private premises and may include a central steel core surrounded by one or more layers of concentric stranded aluminum alloy and coated with zinc to protect from corrosion. In one specific example, the four-aught ASCR cable may include six strands of aluminum alloy concentrically arranged around a single steel core and includes a diameter of about 0.3-0.7 inches, a weight of about 0.1-0.5 pounds per linear foot, and a rated strength of about 8000-8500 lb./ft.

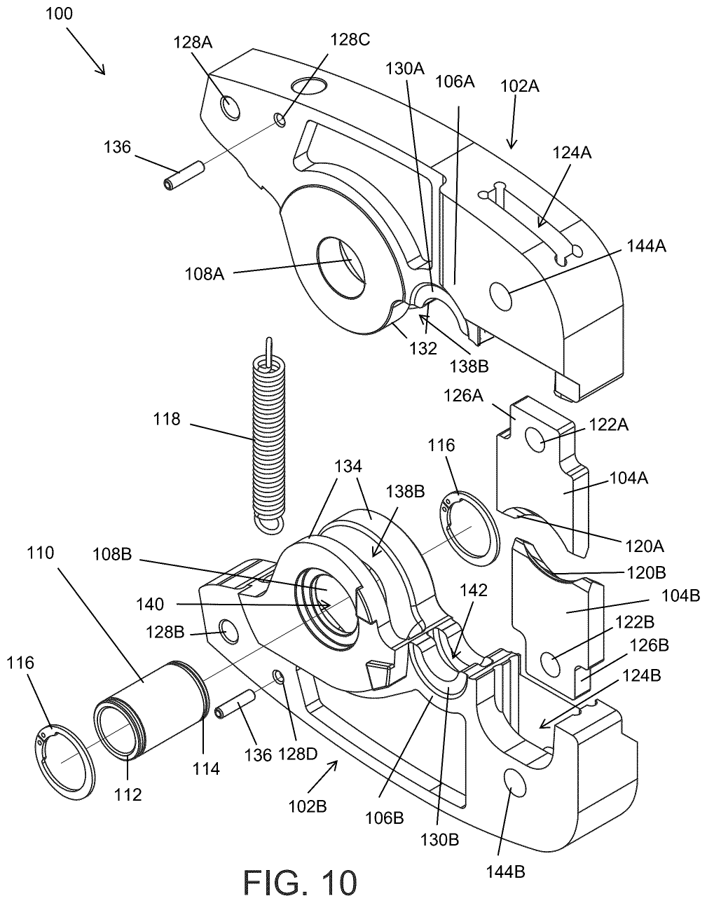

Each respective jaw of the pair of jaws 102A, 102B includes both a blade 104A, 104B and a compression pocket 106A, 106B that are positioned along the length of the respective jaw 102A, 102B, where the respective blades 104A, 104B and respective compression pockets 106A, 106B are sized and shaped or otherwise positioned, according to a non-limiting example, to be used for a four-aught ASCR cable. In one embodiment, the compression pockets 106A, 106B may be sized and shaped to (when used in combination with a crimping die set 130A, 130B) swage (using a fitting/sleeve) or crimp an end of the cable. The compression pocket 106A, 106B may be sized and shaped or otherwise configured to align with various sized crimping die sizes of a crimping die set 130A, 130B, and in a particular example the crimp pockets 106A, 106B may be sized and shaped to fit a crimping die set 130A, 130B having a BG-sized crimping terminal. According to various embodiments, an upper compression pocket 106A may be coupled to an upper crimping die 130A and the lower compression pocket 106B may be coupled to a lower crimping die 130B. The crimping die set 130A, 130B may be configured to perform a double-crimp of the same wire/cable during a single crimping operation. In particular, the crimping dies of the crimping die set 130A, 130B may be concave in shape and be forked or otherwise have a void 142 (see FIG. 10) extending along the length of the crimping die set 130A, 130B such that a wire/cable positioned across the width of the compression portion of the cutting and compression jaw apparatus 100 will have two compression or crimping points during a compression of the wire/cable (i.e., a double crimp) with a space between each crimp where the void 142 was positioned.

In order for an electric or hydraulic powered tool to have sufficient force to crimp cables such as the four-aught ASCR cable described above, at least four tons of force would be needed to crimp the cable. By positioning the compression pockets 106A, 106B more proximate the fulcrum point 140, which corresponds with the central apertures 108A, 108B (see FIG. 10) that traverses the width of both jaws 102A, 102B, the cutting and compression jaw apparatus 100 is able to generate sufficient force to crimp the cable. When the compression pockets 106A, 106B are positioned more distal to the fulcrum point 140, the compression portion may generate at least four tons of force, whereas when the compression pockets are positioned more proximate the fulcrum point 140, the compression portion may generate at least five-and-a-half tons or at least more than six tons of force. Similarly, the amount of force that may be provided by the cutting portion may be at least four tons of force when positioned more distal to the fulcrum point 140 and at least five-and-a-half tons or at least more than six tons of force if positioned more proximal to the fulcrum point 140. During assembly of the cutting and compression jaw apparatus 100, once the central apertures 108A of one jaw 102A are aligned with the central apertures 108B the other jaw 102B, a pivot pin channel 110 may be inserted through all respective central apertures 108A, 108B. One jaw 102A would have two central apertures 108A and the other jaw 102B would also have two central apertures 108B. According to one embodiment of jaw 102A, both of the central apertures 108A protrude through u-shaped or yoke shaped protrusions/ridges 132 positioned around the fulcrum point 140 that are separated by a groove 138A (see FIG. 10). Similarly, according to one embodiment of jaw 102B, the central apertures 108B protrude through u-shaped or yoke-shaped protrusions/ridges 134 positioned around the fulcrum point 140 that are separated by a groove 138B (see FIG. 10). In some embodiments, the protrusions/ridges 132 of jaw 102A and the protrusions/ridges 134 of jaw 102B are configured to hingedly interconnect such that each protrusion/ridge forms a knuckle of the hinged connection such that the pivot pin channel 110 may traverse a total of four knuckles. For example, depending upon orientation and which direction the pivot pin channel 110 is entering the central apertures 108A, 108B, the pivot pin channel 110 would traverse a first knuckle of a first jaw of the jaws 102A, 102B, a second knuckle of the opposite jaw 102A, 102B, a third knuckle of the first jaw of the jaws 102A, 102B, and a fourth knuckle of the opposite jaw 102A, 102B.

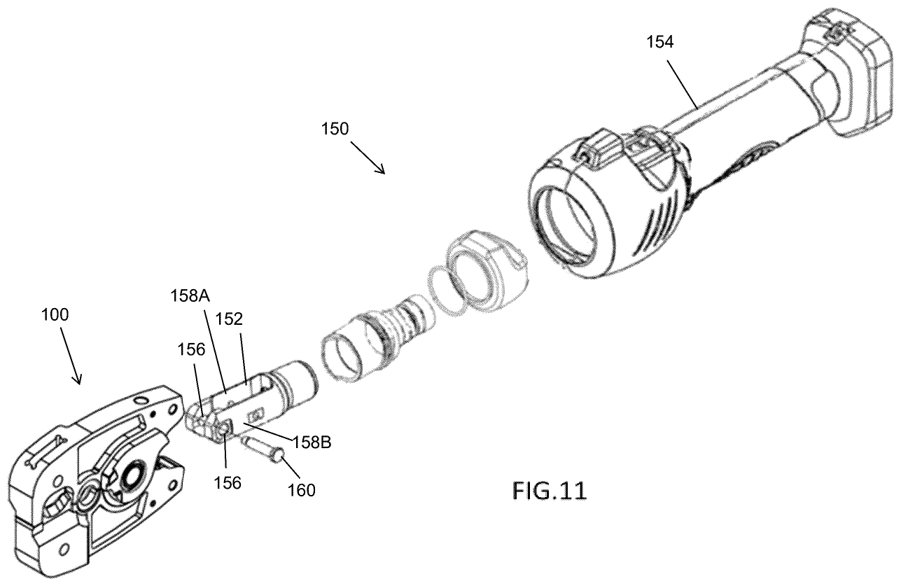

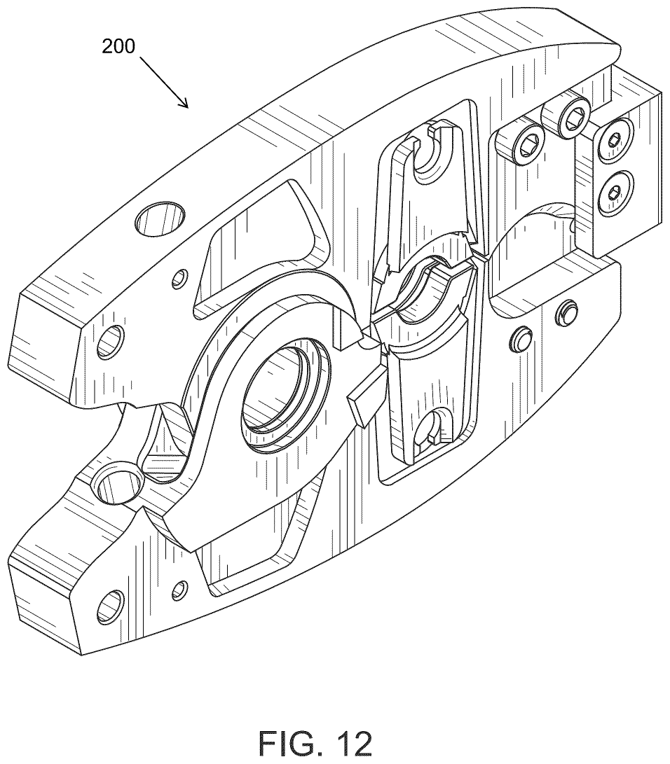

The pivot pin channel 110 may be cylindrically shaped and include respective ends 112, 114 (see FIG. 10) that are sized and shaped or otherwise configured to couple to a respective fastener 116. In one particular example, the respective ends 112, 114 of the pivot pin channel 110 are threaded and the fastener 116 secure to each end of the pivot pin channel 110 when the pivot pin channel 110 is coupled to the jaws 102A, 102B. According to one embodiment, a clevis 152 (see FIG. 11) may be connected to a housing 154 (see FIG. 11) of the body assembly 150 (see FIG. 11) and include bearing eyes 156 (see FIG. 11)) at the ends of the clevis prongs 158A, 158B (see FIG. 11) through which a pin 160 (see FIG. 11) is inserted in order to attach the cutting and compression jaw apparatus 100. For installation of the cutting and compression jaw apparatus 100, when the pivot pin channel 110 is aligned with the bearing eyes 156 of the clevis 152, a shaft of the pin 160 may be inserted through the first bearing eye 156 of the clevis 152, through the pivot pin channel 110, and through the second bearing eye 156 of the clevis 152 such that a pivot pin head of the pin 160, having a greater diameter than the shaft of the pivot pin 160, helps secure the shaft of the pivot pin 160 in place within the bearing eyes 156 of the clevis 152 and the pivot pin channel 110 so that one or more fasteners (not shown) may be connected to the end opposite (a threaded end) the pivot pin head and secure the cutting and compression jaw apparatus 100 to the body assembly 150 (see FIG. 11).

Due to the positioning of the compression pockets 106A, 106B being closer to the fulcrum point 140 and, thus, being able to provide force during operation than more distal portions of the jaws 102A, 102B, more rigid material is needed for the blades 104A, 104B, which are positioned more distal along the length of the jaws 102A, 102B in order to compensate for having less force available. In some embodiments utilizing an electric or hydraulic powered tool, the blades 104A, 104B may be able to generate at least 4-5 tons of force. For example, the amount of force generated by the electric or hydraulic power tool may be approximately 4 tons of force, and then the mechanical advantage provided during compression of the blades 104A, 104B about the fulcrum point 140 may provide an additional 1-2 tons of force at the distal portions of the jaws 102A, 102B that incorporate the blades 104A, 104B. In order to compensate for the difference in force available at the distal portions of the jaws 102A, 102B, the blades 104A, 104B incorporate a rigid material to provide a stronger blade surface. Example rigid materials can include a tungsten carbide material or diamond plated material that form the blade surface to compensate for the positioning of the blades 104A, 104B distally along the length of the jaws 102A, 102B. In some embodiments, the blades 104A, 104B may incorporate diamond particles ingrained within the blade material. If the material of the blades 104A, 104B is not sufficiently rigid, the blades 104A, 104B may buckle due to the rigidity of the cable, which may cause the blades 104A, 104B to flare outward or separate rather than slice through the diameter of the cable.

The blades 104A, 104B may incorporate a blade edge 120A, 120B that is shaped as a chisel or single bevel edge (as depicted), a V-shaped edge, a compound bevel edge, a convex edge, a hollow edge, a sabre edge, a double hollow edge, a double-double bevel edge, or any other edge shape capable of cutting a cable. According to one embodiment, the blades 104A, 104B may be removable or replaceable and incorporate a connection aperture 122A, 122B that align with corresponding connection apertures of the jaws 102A, 102B through which a connection pin (not shown) may be inserted to lock the respective blades 104A, 104B into position and couple the blades 104A, 104B to the jaws 102A, 102B. In particular, the jaws 102A, 102B may each form a blade mount 124A, 124B for housing a coupling portion 126A, 126B (see FIG. 10) of the blades 104A, 104B, the coupling portion 126A, 126B being approximately one-third of the height of the blades 104A, 104B opposite the blade edges 120A, 120B that includes the connection apertures 122A, 122B.

According to one embodiment the cutting and compression jaw apparatus 100 may be biased open using a spring 118 positioned opposite the fulcrum point 140 from the compression pockets 106A, 106B and the blades 104A, 104B. The force applied to the jaws 102A, 102B would overpower the spring force applied by the spring 118 that biases the cutting and compression jaw apparatus 100 to an open position. In some embodiments, the cutting and compression jaw apparatus 100 may include locking pins for use during storage that lock the cutting and compression jaw apparatus 100 at a closed position as a safety feature. The cutting and compression jaw apparatus 100 may includes at least two channels 128A, 128B, with a first channel 128A positioned on a first jaw 102A and a channel 128B positioned on a second jaw 102B. In some embodiments, each jaw 102A, 102B may include additional channels 128C, 128D in addition to the first and second channels 128A, 128B. In some embodiments, the additional channels 128C, 128D may be sized and shaped or otherwise configured to receive a pin 136. According to one embodiment, each of the connection points 128A, 128B may include apertures through which a pin or a fastener may be inserted to attach the cutting and compression jaw apparatus 100 to a body assembly 150 (see FIG. 11) of a motorized tool.

FIG. 11 is a perspective view of an example kit that includes the example cutting and compression jaw apparatus 100 and a body assembly 150. During operation in embodiments that incorporate a hydraulic functionality, the body assembly 150 may include an electric motor, a pump driven by the motor, an extensible piston disposed within a piston cylinder (i.e., a drive), and a housing. The pump may provide pressurized hydraulic fluid to the piston cylinder causing the piston to extend outward from the housing and actuate the jaws 102A, 102B, which pivot about the fulcrum point 140 and apply pressure to a cable positioned between either the blades 104A, 104B or the compression pockets 106A, 106B. When the pressure is released, the piston retracts thereby opening the cutting and compression jaw apparatus 100. In embodiments that incorporate an electromechanical functionality, electrical energy provided by a motor is converted to mechanical energy that actuates a mechanical driver (i.e., a drive), which causes the mechanical driver to extend outward from the housing and actuate the jaws 102A, 102B. During operation, the jaws 102A, 102B pivot about the fulcrum point 140 and apply pressure to a cable positioned between either the blades 104A, 104B or the compression pockets 106A, 106B.

In addition, the spring force applied by the spring 118 causes the cutting and compression jaw apparatus 100 to bias open when not in use.

For embodiments in which the cutting and compression jaw apparatus 100 incorporates purely electric power rather than hydraulic, the body assembly 150 may incorporate an electric linear actuator that converts the rotary motion of the electric motor (i.e., a DC motor) to linear motion. In one embodiment, the linear actuator may be operated by a motor and include a piston rod bearing, a piston rod, a spindle, a barrel housing, a ball screw nut, a spindle bearing, and a drive shaft. The motor may create a rotary motion causing the spindle to rotate. The spindle may be coupled to a helical screw via a drive shaft, which in turn causes the ball screw nut to rotate. The ball screw nut is driven forward or backward during rotation along the helical screw. A hollow piston rod may be coupled to the ball screw nut, and the movement of the ball screw nut may cause the piston rod to move linearly outward, which causes the cutting and compression jaw apparatus 100 to close the jaws 102A, 102B, or to move linearly inward causing the jaws 102A, 102B to retract and open. According to one embodiment, a feedback mechanism provides positional information such that the linear actuator can be programmed to move to a certain position to cut the cable and then return to its rest position. In addition, the spring force applied by the spring 118 causes the cutting and compression jaw apparatus 100 to bias open when not in use.

During a first operation of the cutting and compression jaw apparatus 100, an operator may initially position a wire/cable between the blades 104A, 104B of a cutting portion of the jaws 102A, 102B and perform a cut of the wire/cable by engaging the blades 104A, 104B such that a height of a first blade edge 120A of the first blade 104A at least partially overlaps a height of the second blade edge 102B of the second blade 104B. According to one embodiment, the first operation of cutting the wire/cable provides at least four tons of force, and more particularly about four-and-a-half tons to six tons of force. Once the wire/cable is cut, thereby forming two ends, the blades 104A, 104B are disengaged. One of the ends of the cut wire/cable is then positioned between crimping die of the crimping die set 130A, 130B of a compression portion of the jaws 102A, 102B. During a second operation of the cutting and compression jaw apparatus 100, a compression of one of the ends of the cut wire/cable is performed by engaging the compression portion of the jaws 102A, 102B. According to one embodiment, the compression provided by the second operation provides at least four tons of force, and in a more particular embodiment at least five-and-a-half or six tons of force to compress the end of the cut wire/cable.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiments disclosed herein were chosen and described in order to best explain various aspects and the practical application, and to enable others of ordinary skill in the art to understand various embodiments with various modifications suited to the particular use contemplated.

In one embodiment “embodiment A”, a jaw apparatus includes a first jaw pivotably coupled to a second jaw at a fulcrum point, the first jaw having a first jaw length extending from a first jaw proximal end to a first jaw distal end and the second jaw having a second jaw length extending from a second jaw proximal end to a second jaw distal end, the fulcrum point being positioned more proximate both the first jaw proximal end and the second jaw proximal end than to the first jaw distal end and the second jaw distal end; a first cutting portion positioned along the first jaw length more proximate the first jaw distal end than to the fulcrum point; a second cutting portion positioned along the second jaw length more proximate the second jaw distal end than to the fulcrum point; a first compression portion positioned along the first jaw length in between the fulcrum point and the first cutting portion; and a second compression portion positioned along the second jaw length in between the fulcrum point and the second cutting portion.

In one example of the jaw apparatus of embodiment A, the first cutting portion comprises a first blade mount configured to receive a first detachable blade and the second cutting portion comprises a second blade mount configured to receive a second detachable blade. Further, in some instances, the first blade mount and the second blade mount are aligned along the respective first jaw length and second jaw length when the first jaw and the second jaw are positioned in a closed position, the closed position engaging the first jaw and the second jaw such that the first jaw and the second jaw are adjoining. In addition, in some instances, when the first jaw and the second jaw are in the closed position and the first detachable blade is mounted to the first blade mount and the second detachable blade is mounted to the second blade mount, a first blade edge of the first detachable blade at least partially overlaps with a second blade edge of the second detachable blade. In some embodiments, at least one of the first blade edge and the second blade edge is concave.

In some instances, the first compression portion of embodiment A includes a first compression pocket configured to receive a first compression die of a compression die set and the second compression portion of embodiment A includes a second compression pocket configured to receive a second compression die of the compression die set, wherein the first compression pocket and the second compression pocket are each semi-circular in shape such that a circular aperture is formed when the first compression pocket and the second compression pocket are aligned and adjoining.

In some instances of embodiment A, the first jaw is pivotally coupled to the second jaw at the fulcrum point via a hinged connection between multiple knuckles, the multiple knuckles including a first knuckle of the first jaw, a second knuckle of the second jaw, a third knuckle of the first jaw, and a fourth knuckle of the second jaw, wherein a first receiving channel is positioned between the first knuckle and the third knuckle of the first jaw that is configured to receive one of the second knuckle and the fourth knuckle of the second jaw, and a second receiving channel is positioned between the second knuckle and the fourth knuckle of the second jaw that is configured to receive one of the first knuckle and the third knuckle of the first jaw. Further, in some instances, each of the first knuckle, the second knuckle, the third knuckle, and the fourth knuckle comprise respective central apertures passing therethrough at the fulcrum point, the respective central apertures being configured to receive a pivot pin channel. In some examples, the pivot pin channel comprises a cylinder having first end configured to receive a first fastener and having a second end opposite the first end configured to receive a second fastener.

In some instances of embodiment A, the jaw apparatus further includes a spring connecting the first jaw and the second jaw, the spring being positioned along the first jaw length relative the fulcrum point opposite from the first cutting portion and first compression portion of the first jaw and being positioned along the second jaw length relative the fulcrum point opposite from the second cutting portion and the second compression portion of the second jaw. In some instances, the spring is configured to bias open the first jaw and the second jaw when the jaw apparatus is not in operation. Further, in some instances, the first cutting portion and the second cutting portion are capable of providing at least four tons of force when engaged, and wherein the first compression portion and the second compression portion are capable of providing at least four tons of force when engaged.

In another embodiment, “embodiment B” a cutting a compression kit is disclosed that includes a cutting and compression jaw apparatus and a body assembly that includes a drive for operating the cutting and compression jaw apparatus. The cutting and compression jaw apparatus includes a first jaw pivotably coupled to a second jaw at a fulcrum point, the first jaw having a first jaw length extending from a first jaw proximal end to a first jaw distal end and the second jaw having a second jaw length extending from a second jaw proximal end to a second jaw distal end, the fulcrum point being positioned more proximate both the first jaw proximal end and the second jaw proximal end than to the first jaw distal end and the second jaw distal end. The cutting and compression jaw apparatus also includes a first cutting portion positioned along the first jaw length more proximate the first jaw distal end than to the fulcrum point. In addition, the cutting and compression jaw apparatus includes a second cutting portion positioned along the second jaw length more proximate the second jaw distal end than to the fulcrum point, and a first compression portion positioned along the first jaw length in between the fulcrum point and the first cutting portion. The cutting and compression jaw apparatus also includes a second compression portion positioned along the second jaw length in between the fulcrum point and the second cutting portion.

In some examples of embodiment B, the drive comprises at least one of an electromechanical drive and a hydraulic drive, wherein the drive is configured to pivot the first jaw relative the second jaw during operation.

The first cutting portion of embodiment B may also include a first blade mount configured to receive a first detachable blade and the second cutting portion comprises a second blade mount configured to receive a second detachable blade. Further, the first blade mount and the second blade mount may be aligned along the respective first jaw length and second jaw length when the first jaw and the second jaw are positioned in a closed position, the closed position engaging the first jaw and the second jaw such that the first jaw and the second jaw are adjoining

In some examples of embodiment B, the first compression portion comprises a first compression pocket configured to receive a first compression die of a compression die set and the second compression portion comprises a second compression pocket configured to receive a second compression die of the compression die set, wherein the first compression pocket and the second compression pocket are each semi-circular in shape such that a circular aperture is formed when the first compression pocket and the second compression pocket are aligned and adjoining.

Also disclosed herein is a method that includes positioning an object to be cut between a first cutting portion of a first jaw of a cutting and compression apparatus and a second cutting portion of a second jaw of the cutting and compression apparatus, the first jaw having a first jaw length extending from a first jaw proximal end to a first jaw distal end and the second jaw having a second jaw length extending from a second jaw proximal end to a second jaw distal end, the cutting and compression apparatus including a fulcrum point positioned more proximate both the first jaw proximal end and the second jaw proximal end than to the first jaw distal end and the second jaw distal end, wherein the first cutting portion is positioned along the first jaw length more proximate the first jaw distal end than to the fulcrum point, and the second cutting portion is positioned along the second jaw length more proximate the second jaw distal end than to the fulcrum point. The method also includes engaging at least one of the first jaw and the second jaw such that a first blade of the first cutting portion engages a second blade of the second cutting portion, thereby cutting the object into a first portion and a second portion. In addition, the method includes positioning one of the first portion and the second portion between a first compression portion of the first jaw and a second compression portion of the second jaw, the first compression portion being positioned along the first jaw length in between the fulcrum point and the first cutting portion, and the second compression portion being positioned along the second jaw length in between the fulcrum point and the second cutting portion. Further, the method includes re-engaging the at least one of the first jaw and the second jaw such that the first compression portion engages with the second compression portion thereby compressing the one of the first portion and the second portion positioned between the first compression portion and the second compression portion.

In some examples of the method, engaging the at least one of the first jaw and the second jaw includes activating an electromechanical drive operatively coupled to at least one of the first jaw and the second jaw, and the re-engaging the at least one of the first jaw and the second jaw comprises re-activating the electromechanical drive.

In some examples of the method, engaging the at least one of the first jaw and the second jaw applies at least four tons of force to the object, and wherein the re-engaging the at least one of the first jaw and the second jaw applies at least four tons of force.

In another embodiment, “embodiment C” a device includes a first cutting portion, a second cutting portion spatially positioned to engage the first cutting portion during a cutting operation, a first compression portion, a second compression portion spatially positioned to engage the first compression portion during a compression operation, and an engaging mechanism. The engaging mechanism is operatively coupled to the first cutting portion, the second cutting portion, the first compression portion, and the second compression portion. Further, the engaging mechanism is configured to perform the cutting operation by engaging the first cutting portion and the second cutting portion, and the compression operation by engaging the first compression portion and the second compression portion.

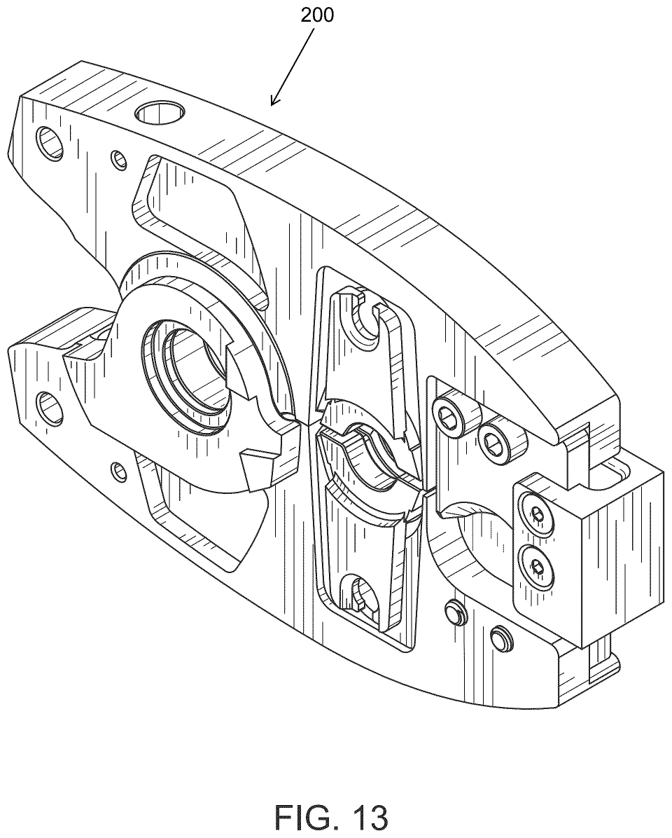

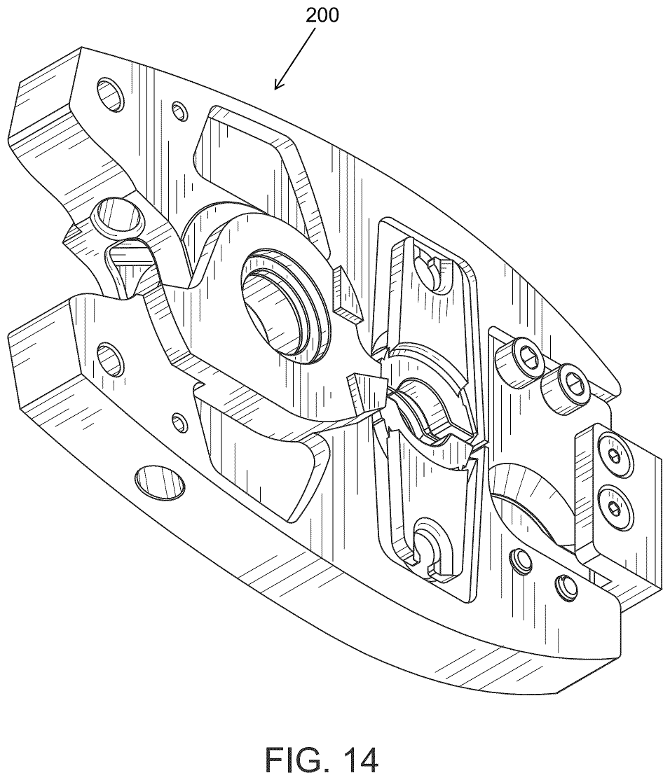

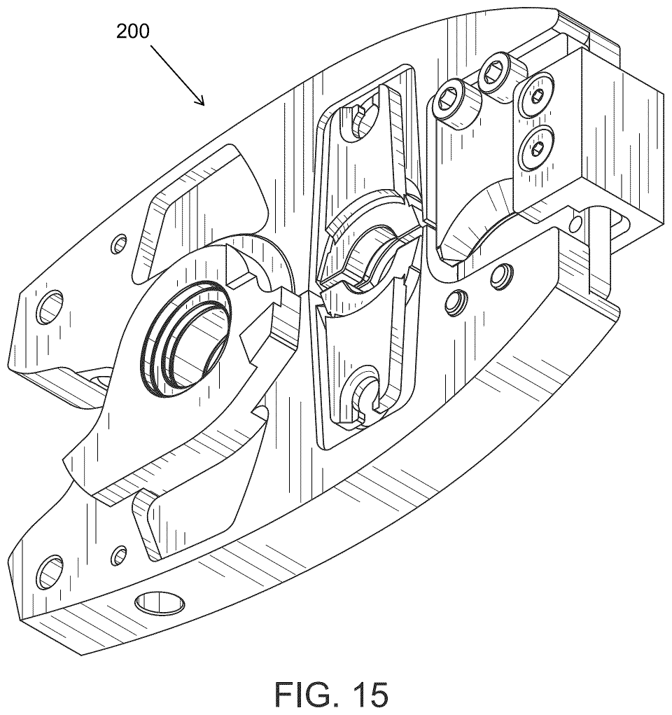

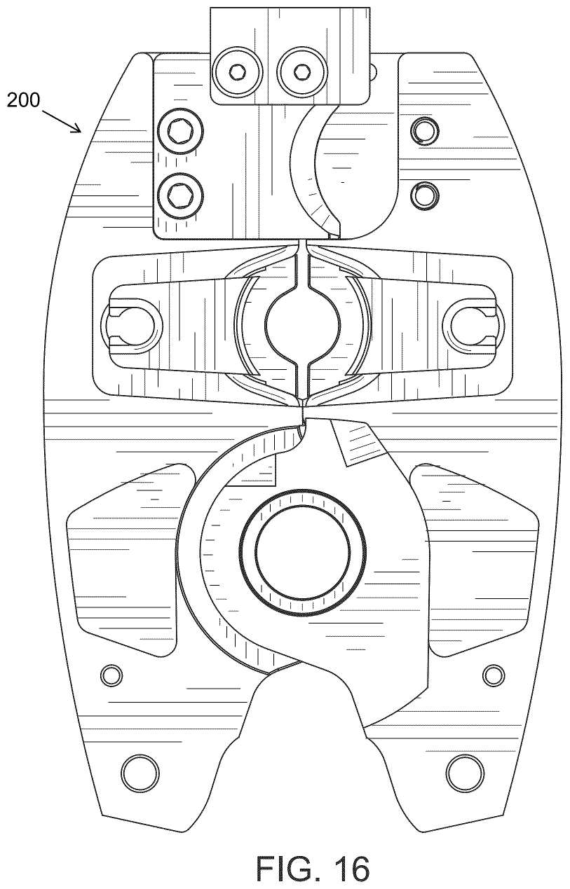

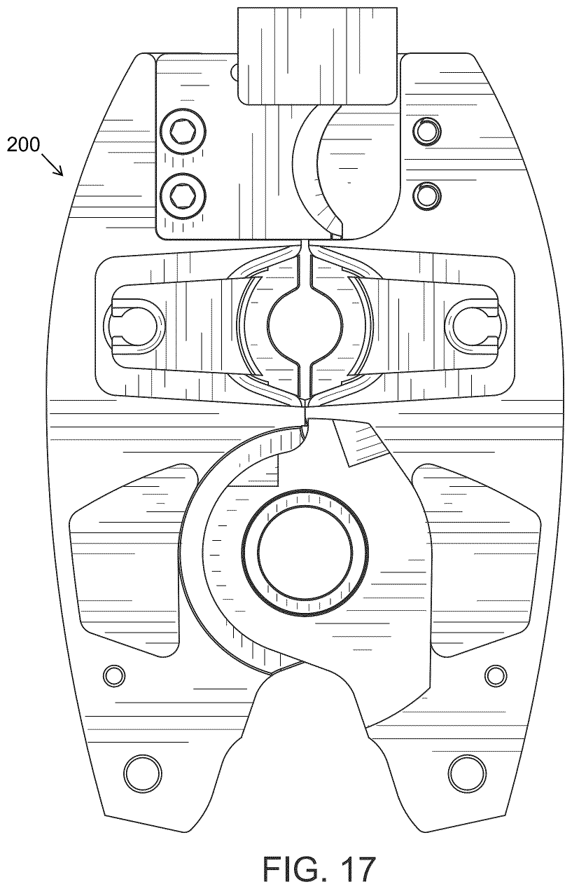

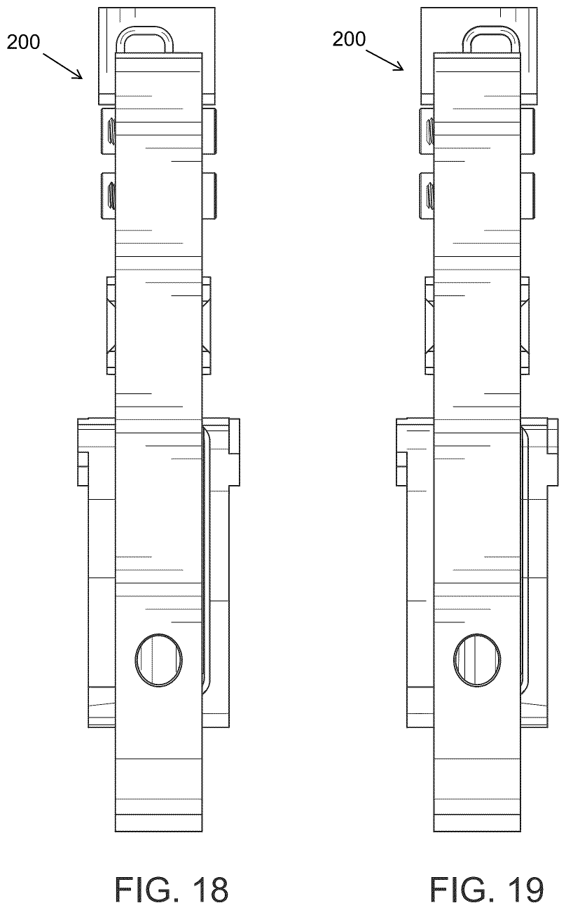

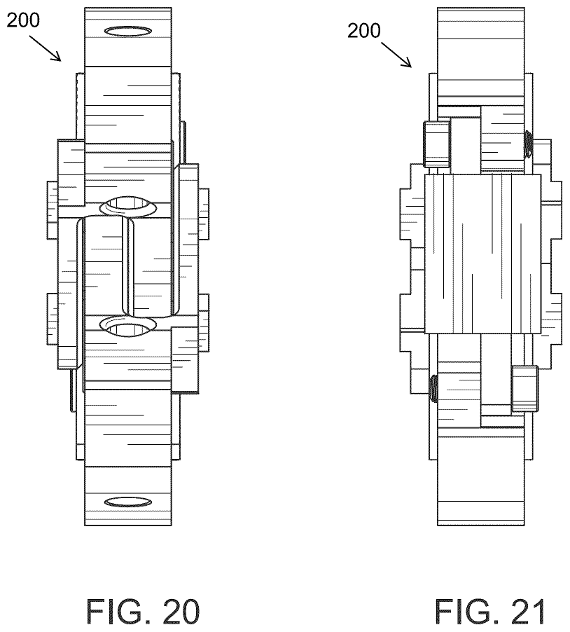

In one example of the device 200 of embodiment C, as depicted by FIGS. 12-21, the first cutting portion is a first blade mount configured to receive a first detachable blade and the second cutting portion is a second blade mount configured to receive a second detachable blade. In some instances, when the first detachable blade is mounted to the first blade mount and the second detachable blade is mounted to the second blade mount, a first blade edge of the first detachable blade at least partially overlaps with a second blade edge of the second detachable blade during the cutting operation.

In another example of the device of embodiment C, the first cutting portion includes a first blade integrally fixed to the first cutting portion and the second cutting portion includes a second blade integrally fixed to the second cutting portion

In another example of the device of embodiment C, the first compression portion is a first compression pocket configured to receive a first compression die of a compression die set and the second compression portion is a second compression pocket configured to receive a second compression die of the compression die set, wherein the first compression die and the second compression die are each semi-circular in shape such that a circular aperture is formed when the first compression die and the second compression die are aligned during the compression operation.

In some examples of the device of embodiment C, the first cutting portion and the first compression portion are positioned on a first jaw that is coupled to a second jaw via the engaging mechanism, and the second cutting portion and the second compression portion are positioned on the second jaw.

In one particular iteration, the first jaw has a first jaw length extending from a first jaw proximal end to a first jaw distal end and the second jaw has a second jaw length extending from a second jaw proximal end to a second jaw distal end, the engaging mechanism is positioned more proximate both the first jaw proximal end and the second jaw proximal end than to the first jaw distal end and the second jaw distal end, the first cutting portion is positioned along the first jaw length more proximate the first jaw distal end than to the engaging mechanism, the second cutting portion is positioned along the second jaw length more proximate the second jaw distal end than to the engaging mechanism, the first compression portion is positioned along the first jaw length in between the engaging mechanism and the first cutting portion, and the second compression portion is positioned along the second jaw length in between the engaging mechanism and the second cutting portion.

In another iteration, the first jaw has a first jaw length extending from a first jaw proximal end to a first jaw distal end and the second jaw has a second jaw length extending from a second jaw proximal end to a second jaw distal end, the engaging mechanism is operatively coupled to the first jaw proximate the first jaw proximal end and coupled to the second jaw proximate the second jaw proximal end, the first cutting portion is positioned along the first jaw length more proximate the engaging mechanism than the first jaw distal end, the second cutting portion is positioned along the second jaw length more proximate the engaging mechanism than the second jaw distal end, the first compression portion is positioned along the first jaw length in between the first cutting portion and the first jaw distal end, and the second compression portion is positioned along the second jaw length in between the second cutting portion and the second jaw distal end.

In some examples of the device of embodiment C, the engaging mechanism includes a fulcrum. In some examples of the device of embodiment C, the engaging mechanism is hydraulically powered.

In some examples of the device of embodiment C, the first cutting portion includes a blade mount for receiving a removable blade and the first compression portion includes a compression pocket for receiving a removable crimping die. In some examples the removable crimping die and the removable blade are coupled one to another such that there is a single replacement piece for engaging both the blade mount and the compression pocket.

In some examples of the device of embodiment C, the second cutting portion includes a blade mount for receiving a removable blade and the second compression portion includes a compression pocket for receiving a removable crimping die. In some examples the removable crimping die and the removable blade are coupled one to another such that there is a single replacement piece for engaging both the blade mount and the compression pocket.

In some examples of the device of embodiment C, the first cutting portion and the second cutting portion are capable of providing at least four tons of force when engaged, and wherein the first compression portion and the second compression portion are capable of providing at least four tons of force when engaged.

In some examples of the device of embodiment C, the engaging mechanism is operatively coupled to a linear actuator, wherein the linear actuator is configured to engage the engaging mechanism during operation. Further, the linear actuator may be capable of providing at least four tons of force to the engaging mechanism, and in some cases at least five or at least six tons of force to the engaging mechanism.

In another iteration of embodiment C, the first cutting portion and the first compression portion are positioned on a first jaw, the first jaw having a first jaw length that extends from a first jaw proximal end to a first jaw distal end, the engaging mechanism being positioned proximate the first jaw proximal end, wherein the first cutting portion and the first compression portion are positioned equidistant along the first jaw length such that the first cutting portion and the first compression portion are positioned in parallel and are adjoining, wherein the second cutting portion and the second compression portion are positioned on a second jaw, the second jaw having a second jaw length that extends from a second jaw proximal end to a second jaw distal end, the engaging mechanism being positioned proximate the second jaw proximal end, wherein the second cutting portion and the second compression portion are positioned equidistant along the second jaw length such that the second cutting portion and the second compression portion are positioned in parallel and are adjoining. In some embodiments, the first cutting portion and the first compression portion are configured to engage a cable at a one position and the second cutting portion and the second compression portion are configured to engage the same cable at another position. The cutting operation and the compression operation may then be performed sequentially, according to one embodiment. In another embodiment, a single operation of the device may perform both the cutting operation and the compression operation sequentially such that only one input is required by a user. In this iteration the first jaw and the second jaw would have a relatively thicker width in order to have both the respective cutting portions and the respective compression portions both positioned at an equidistant position such that the width is wide enough to include both the cutting portions and the crimping portions. In some instances of this iteration, the cutting portion and the compression portion are both configured to receive either a cutting blade or a compression die so that when the device is activated, the cutting blade could optionally be positioned to the right mount/pocket/socket/etc. or the left mount/pocket/socket/etc. and the compression die would be placed in the other mount/pocket/socket/etc. Accordingly, if the operator desired to have the cut placed to the left and the compression to the right, then when the single operation is performed the cable end to the right of the device would be crimped/compressed. Similarly, if the operator desired to have the cut placed to the right and the compression to the left, then the cable end to the left of the device would be crimped/compressed. In some instances, the cutting portion and the compression portion are interchangeable so that if the cutting blade is not able to mount to the compression pocket that the compression pocket could switch places with the cutting blade mount within the head of the device.

In one embedment, referred to as “embodiment D”, the device includes a first cutting portion positioned on a fixed head, a first compression portion also positioned on the fixed head, a second cutting portion spatially positioned to engage the first cutting portion during a cutting operation, a second compression portion spatially positioned to engage the first compression portion during a compression operation, and an engaging mechanism operatively coupled to the second cutting portion and the second compression portion. Further, the engaging mechanism is configured to perform (i) the cutting operation by moving the second cutting portion towards the first cutting portion, and (ii) the compression operation by moving the second compression portion towards the first compression portion.

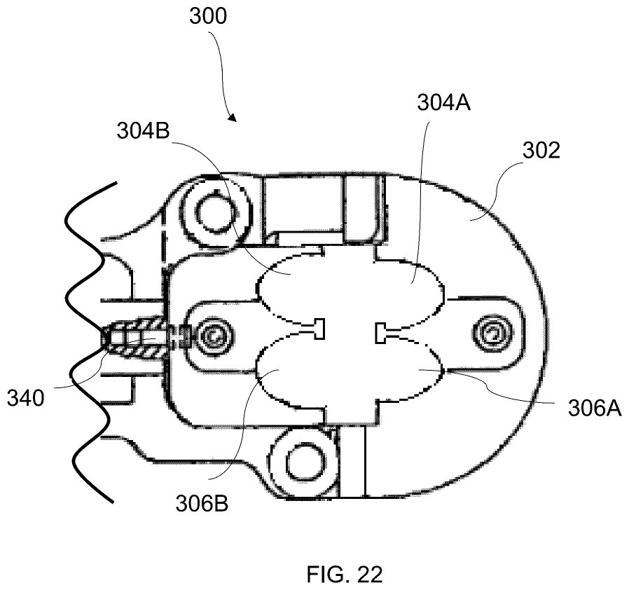

In some instances of embodiment D, as depicted by FIG. 22, the fixed head 302 of the device 300 is a closed head. The device 300 depicts a first cutting portion 304A and a first compression portion 306A, which are affixed to the fixed head 302. The device 300 also depicts a second cutting portion 304B and a second compression portion 306B that are attached to an engaging mechanism 340. The engaging mechanism 340 may be a linear actuator that pushes the second cutting portion 304B and the second compression portion 306B towards the first cutting portion 304A and the first compression portion 306A during operation of the device. As depicted, the first cutting portion 304A, the first compression portion 306A, the second cutting portion 304B, and the second compression portion 306B may form mounts/pockets/sockets/etc. so that a blade or crimping die may be placed therein.

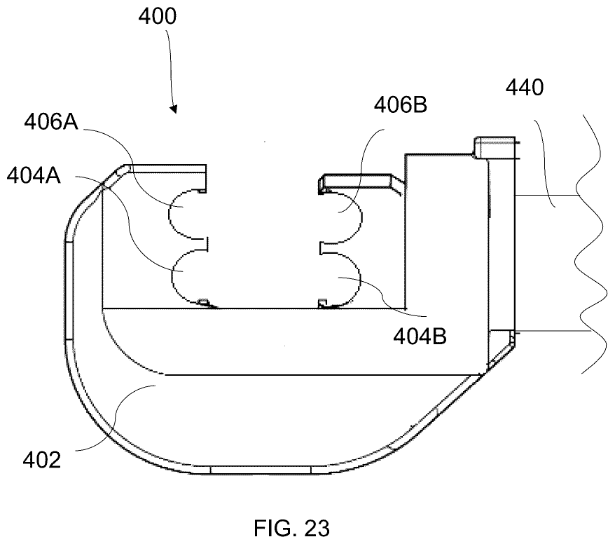

In other instances of embodiment D, as depicted by FIG. 23, the fixed head 402 of the device 400 is C-shaped. The device 400 depicts a first cutting portion 404A and a first compression portion 406A, which are affixed to the fixed head 402. The device 400 also depicts a second cutting portion 404B and a second compression portion 406B that are attached to an engaging mechanism 440. The engaging mechanism 440 may be a linear actuator that pushes the second cutting portion 404B and the second compression portion 406B towards the first cutting portion 404A and the first compression portion 406A during operation of the device. As depicted, the first cutting portion 404A, the first compression portion 406A, the second cutting portion 404B, and the second compression portion 406B may form mounts/pockets/sockets/etc. so that a blade or crimping die may be placed therein.

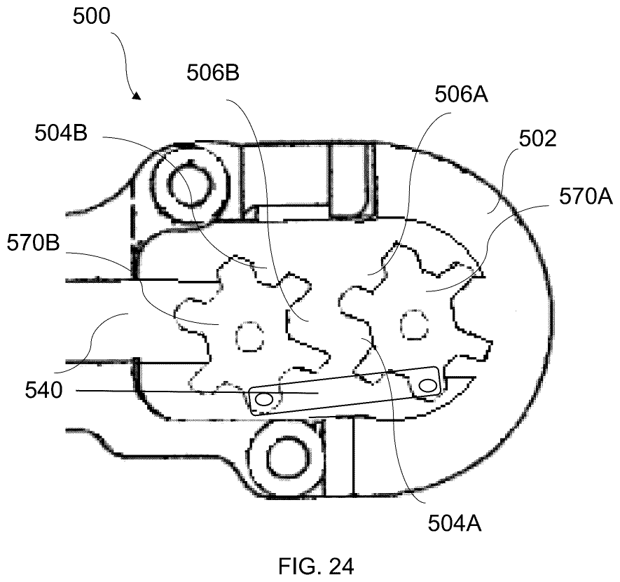

In another embodiment, referred to as “embodiment E”, and as depicted by FIG. 24, the device 500 includes a first cutting portion 504A positioned on a first rotatable support 570A, a first compression portion 506A also positioned on the first rotatable support 570A, a second cutting portion 504B positioned on a second rotatable support 570B, a second compression portion 506B also positioned on the second rotatable support 570B, and an engaging mechanism 540 operatively coupled to the first rotatable support 570A and the second rotatable support 570B. In addition, the engaging mechanism 540 is configured to rotate the first rotatable support 570A to position the first cutting portion 504A for a cutting operation and configured to rotate the second rotatable support 570B to align the second cutting portion 504B with the first cutting portion 504A for the cutting operation. Further, the engaging mechanism 540 is configured to rotate the first rotatable support 570A to position the first compression portion 506A for a crimping operation and configured to rotate the second rotatable support 570B to align the second compression portion 506B with the first compression portion 506A for the crimping operation, the crimping operation being a separate operation than the cutting operation. The first rotatable support 570A may be coupled to a fixed head 502, according to one embodiment.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiments disclosed herein were chosen and described in order to best explain various aspects and the practical application, and to enable others of ordinary skill in the art to understand various embodiments with various modifications suited to the particular use contemplated.

What is claimed is:

1. A device, comprising:
a first cutting portion;
a second cutting portion spatially positioned to engage the first cutting portion during a cutting operation;
a first compression portion;
a second compression portion spatially positioned to engage the first compression portion during a compression operation; and
an engaging mechanism operatively coupled to the first cutting portion, the second cutting portion, the first compression portion, and the second compression portion, wherein the engaging mechanism is configured to perform (i) the cutting operation by engaging the first cutting portion and the second cutting portion, and (ii) the compression operation by engaging the first compression portion and the second compression portion.

2. The device of claim 1, wherein the first cutting portion is a first blade mount configured to receive a first detachable blade and the second cutting portion is a second blade mount configured to receive a second detachable blade.

3. The device of claim 2, wherein when the first detachable blade is mounted to the first blade mount and the second detachable blade is mounted to the second blade mount, a first blade edge of the first detachable blade at least partially overlaps with a second blade edge of the second detachable blade during the cutting operation.

4. The device of claim 1, wherein the first cutting portion includes a first blade integrally fixed to the first cutting portion and the second cutting portion includes a second blade integrally fixed to the second cutting portion.

5. The device of claim 1, wherein the first compression portion is a first compression pocket configured to receive a first compression die of a compression die set and the second compression portion is a second compression pocket configured to receive a second compression die of the compression die set, wherein the first compression die and the second compression die are each semi-circular in shape such that a circular aperture is formed when the first compression die and the second compression die are aligned during the compression operation.

6. The device of claim 1, wherein the first cutting portion and the first compression portion are positioned on a first jaw that is coupled to a second jaw via the engaging mechanism, and the second cutting portion and the second compression portion are positioned on the second jaw.

7. The device of claim 6, wherein the first jaw has a first jaw length extending from a first jaw proximal end to a first jaw distal end and the second jaw has a second jaw length extending from a second jaw proximal end to a second jaw distal end, the engaging mechanism is positioned more proximate both the first jaw proximal end and the second jaw proximal end than to the first jaw distal end and the second jaw distal end, the first cutting portion is positioned along the first jaw length more proximate the first jaw distal end than to the engaging mechanism, the second cutting portion is positioned along the second jaw length more proximate the second jaw distal end than to the engaging mechanism, the first compression portion is positioned along the first jaw length in between the engaging mechanism and the first cutting portion, and the second compression portion is positioned along the second jaw length in between the engaging mechanism and the second cutting portion.

8. The device of claim 6, wherein the engaging mechanism includes a fulcrum.

9. The device of claim 6, wherein the first jaw has a first jaw length extending from a first jaw proximal end to a first jaw distal end and the second jaw has a second jaw length extending from a second jaw proximal end to a second jaw distal end, the engaging mechanism is operatively coupled to the first jaw proximate the first jaw proximal end and coupled to the second jaw proximate the second jaw proximal end, the first cutting portion is positioned along the first jaw length more proximate the engaging mechanism than the first jaw distal end, the second cutting portion is positioned along the second jaw length more proximate the engaging mechanism than the second jaw distal end, the first compression portion is positioned along the first jaw length in between the first cutting portion and the first jaw distal end, and the second compression portion is positioned along the second jaw length in between the second cutting portion and the second jaw distal end. 10 The device of claim 1, wherein the engaging mechanism is hydraulically powered.

11. The device of claim 1, wherein the first cutting portion includes a blade mount for receiving a removable blade and the first compression portion includes a compression pocket for receiving a removable crimping die.

12. The device of claim 1, wherein the second cutting portion includes a blade mount for receiving a removable blade and the second compression portion includes a compression pocket for receiving a removable crimping die.

13. The device of claim 1, wherein the first cutting portion and the second cutting portion are capable of providing at least four tons of force when engaged, and wherein the first compression portion and the second compression portion are capable of providing at least four tons of force when engaged.

14. The device of claim 1, wherein the engaging mechanism is operatively coupled to a linear actuator, wherein the linear actuator is configured to engage the engaging mechanism during operation.

15. The device of claim 14, wherein the linear actuator is capable of providing at least four tons of force to the engaging mechanism.

16. The device of claim 1, wherein the device is configured to perform the cutting operation and the compression operation sequentially.

17. A device, comprising:
a first cutting portion positioned on a fixed head;
a first compression portion also positioned on the fixed head;
a second cutting portion spatially positioned to engage the first cutting portion during a cutting operation;
a second compression portion spatially positioned to engage the first compression portion during a compression operation; and
an engaging mechanism operatively coupled to the second cutting portion and the second compression portion, wherein the engaging mechanism is configured to perform (i) the cutting operation by moving the second cutting portion towards the first cutting portion, and (ii) the compression operation by moving the second compression portion towards the first compression portion.

18. The device of claim 17, wherein the fixed head is C-shaped.

19. The device of claim 17, wherein the fixed head is a closed head.

20. A device, comprising:
a first cutting portion positioned on a first rotatable support;
a first compression portion also positioned on the first rotatable support;
a second cutting portion positioned on a second rotatable support;
a second compression portion also positioned on the second rotatable support; and
an engaging mechanism operatively coupled to the first rotatable support and the second rotatable support;
wherein the engaging mechanism is configured to rotate the first rotatable support to position the first cutting portion for a cutting operation and configured to rotate the second rotatable support to align the second cutting portion with the first cutting portion for the cutting operation;
wherein the engaging mechanism is configured to rotate the first rotatable support to position the first compression portion for a crimping operation and configured to rotate the second rotatable support to align the second compression portion with the first compression portion for the crimping operation, the crimping operation being a separate operation than the cutting operation.
